(19) United States
(12) Patent Application Publication
(10) Pub. No.: US 2013/0140790 A1
(43) Pub. Date: Jun. 6, 2013

(54) TRAINER

(71) Applicant: Richard George Gladwin, Randburg (ZA)

(72) Inventor: Richard George Gladwin, Randburg (ZA)

(21) Appl. No.: 13/807,780

(22) PCT Filed: Sep. 29, 2010
(86) PCT No.: PCT/ZA2010/000058

§ 371 Date: Feb. 21, 2013

(30) Foreign Application Priority Data
Jun. 30, 2010 (ZA) 2010/04587

(51) Int. Cl. B62H 7/00

(52) U.S. Cl. CPC B62H 7/00
USPC 280/293

(57) ABSTRACT

A cycling trainer which includes a wheeled body with a rear wheel centred on an axis and a support on each side of the wheel to provide lateral support to the rear wheel and therefore the trainer, wherein each support may have at least one circular zone of relative weakness about which the respective support flexes, bends, deflects or breaks.

### BACKGROUND OF THE INVENTION

This invention relates to a training device for a person such as a child learning to cycle.

A number of devices are known that are used in an attempt to teach children to cycle. One such device is what is commonly known as a push bike. Another device is a set of training wheels that attach to the back axle of a bicycle with the wheels positioned on either side of the back wheel to provide lateral support.

Push bikes typically have two wheels at the rear. These bikes are pushed by a child using his legs hence the name. Consequently little opportunity is afforded by such bikes in allowing a child to learn to balance, a first step in learning to ride a bicycle as these rear wheels provide almost total lateral support.

When a child graduates from a push bike to a traditional bicycle, the child often needs support for an interim period. This support is often provided by a pair of the aforementioned training wheels which can be detached from the bicycle when no longer needed. The problem with such wheels is that, as they laterally extend, they tend to catch on adjacent objects when the bicycle is in motion. They are also cumbersome and weighty.

The invention aims to at least partially address the aforementioned problems.

### SUMMARY OF INVENTION

The invention provides a cycling trainer which includes a wheeled body with a rear wheel centred on an axis and a support on each side of the wheel to provide lateral support to the rear wheel and therefore the trainer, wherein each support may have at least one circular zone of relative weakness about which the respective support flexes, bends, deflects or breaks.

Preferably the body of the trainer is blow-moulded from a suitable rigid plastics material, for example polypropylene.

The zone may be a single continuous recess or groove or it may comprise of a plurality of recesses, grooves or holes, circularly arranged.

Alternatively, the zone may be adapted to be more resiliently deformable relatively to adjacent sections of the support. The zone may be made sectionally thinner or of a softer material relatively to adjacent sections of the support.

The circular zone may divide the support into a perimeter ring section and an inner section.

The zone may be adapted to sever or break at least partially there-along after a predetermined period of use of the trainer or cause the respective support to bend, flex or deflect thereabout. The effect of each of these resultant actions is effectively a reduction in the diameter of the support and therefore a reduction in lateral support provided to the trainer.

In the event that the support breaks along the zone the perimeter ring section may detach from the support leaving the inner section.

Preferably, each support includes a plurality of circular zones of relative weakness, concentrically arranged, which therebetween provide for a plurality of support sections, each of which may become a perimeter support section, in turn, when an adjacent perimeter ring section detaches from the respective support along a respective circular zone. In this manner, the support's diameter progressively reduces over time with use.

Alternatively, the support may bend or resiliently deform, about each circular zone, after a predetermined period of use, resulting in each support providing less and less lateral support to the trainer as each support section progressively inwardly deforms.

Each support may be integrally formed with a respective side of the wheel.

Each support may be a dish-shaped or tubular body.

Alternatively, each support may be a discrete unit, centred on the axis spaced from a respective side of the wheel.

Each dish-shaped support may have an outer surface which is concave relatively to the wheel, with an outer rim which extends laterally from a respective side of the wheel to provide the lateral support.

In a second aspect of the invention there is provided a rear wheel for a bicycle which includes a circular or tubular formation integrally formed with the wheel, on each side thereof, each of which extends laterally from a respective side of the wheel to provide lateral support to the wheel when in use.

The term “bicycle” is used herein to include a two-wheeled vehicle, either pedal-driven or driven by a user's legs pushing against the ground.

Each formation may have a circular zone of relative weakness which is adapted to sever or break at least partially there-along after a predetermined period of use. The zone may be a single continuous recess or groove or it may comprise of a plurality of recesses, grooves or holes, circularly arranged.

Alternatively, the zone may be made of a softer or more resiliently deformable material relatively to the material making up adjacent sections of the support about which an adjacent outer section of the formation bends inwardly relatively to an adjacent inner section of the formation.

In another aspect of the invention there is provided a bicycle support which is attachable to a back axle of a bicycle and which has a circular or tubular body which includes at least one circular zone of relative weakness.

The zone of relative weakness divides the support into an outer ring section and an inner ring section.

The circular body may be dish-shaped, with an outer surface concave relatively to the wheel.

The outer ring section of each support may include at least one discontinuity which radiates from the zone of relative weakness to the perimeter of the support, which divides the outer ring section into at least two segments and which allows each segment of the outer ring section to detach from the inner section discretely, independently of the outer segment.

### BRIEF DESCRIPTION OF THE DRAWINGS

The invention is further described by way of examples with reference to the accompanying drawings in which:

FIG. 1 illustrates, from one side, a bicycle, showing a rear wheel with a support in accordance with the invention;

FIG. 2 illustrates, from a rear side, the bicycle, showing a pair of supports, one on either side of the rear wheel;

FIG. 3 illustrates, from a rear side, the bicycle, showing a pair of supports in accordance with a second embodiment of the invention, with each of the supports spaced from the rear wheel;

FIG. 4 illustrates the bicycle again from a rear side showing the supports;

FIG. 5 illustrates a rear view of the bicycle with a perimeter ring of one of the supports detached therefrom;

FIG. 6 illustrates a rear view of the bicycle tilted to one side and showing one of the supports engaging the ground in lateral support;

FIG. 7 illustrates a side view of a cycling trainer with a rear wheel and integrally moulded support structure in accordance with another aspect of the invention;

FIG. 8 illustrates a similar view with the rear wheel and support structure of the trainer illustrated in FIG. 7;

FIG. 9 is a view in perspective of the rear wheel and support structure; and

FIG. 10 is a cross section of the rear wheel and support structure.

### DESCRIPTION OF PREFERRED EMBODIMENT

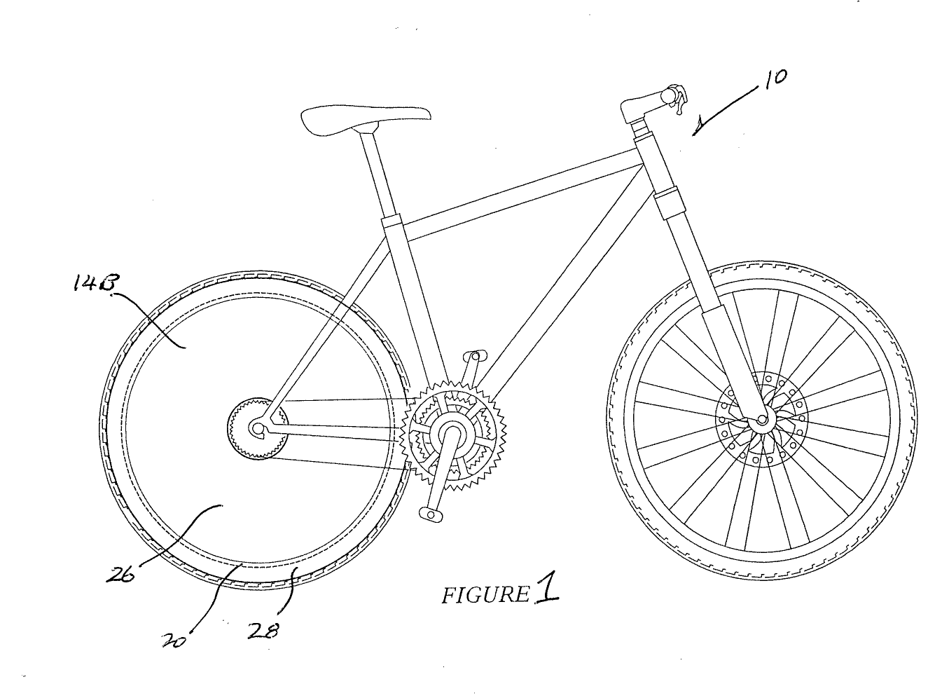

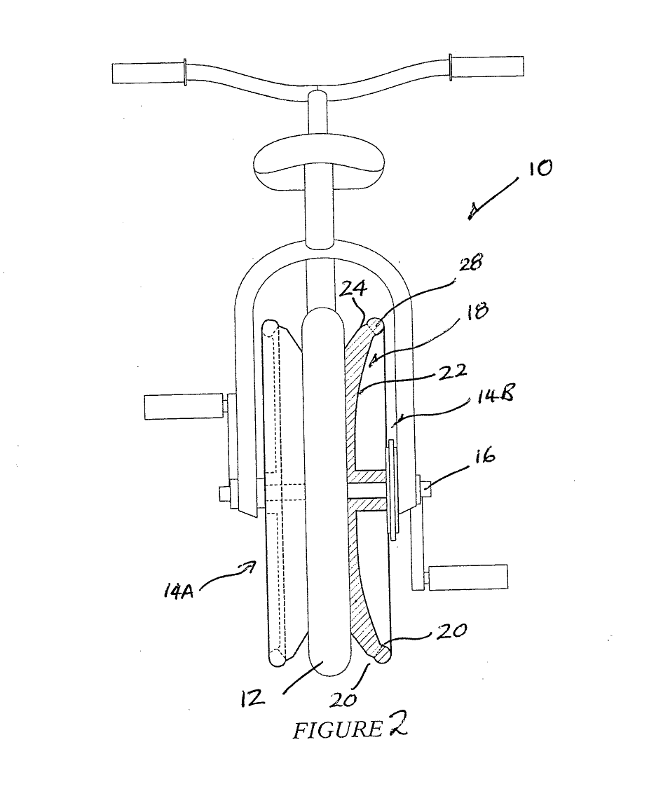

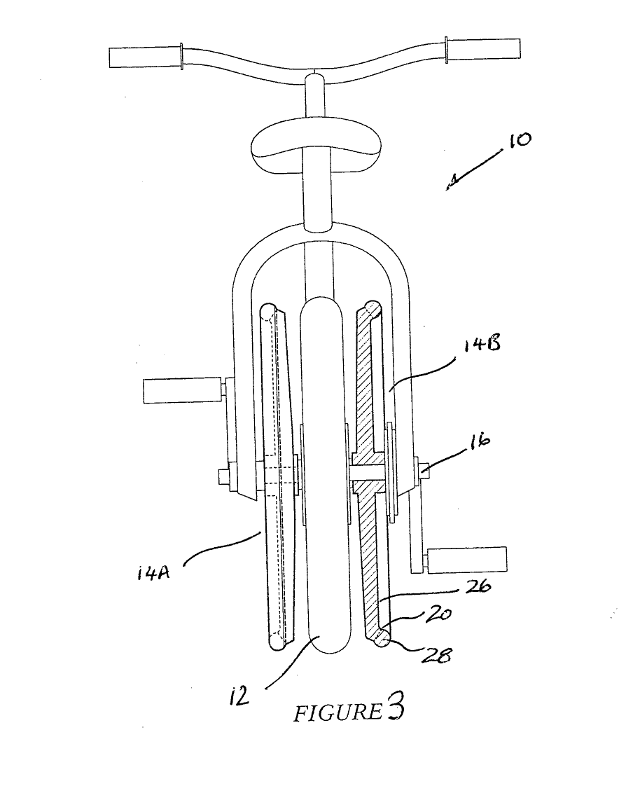

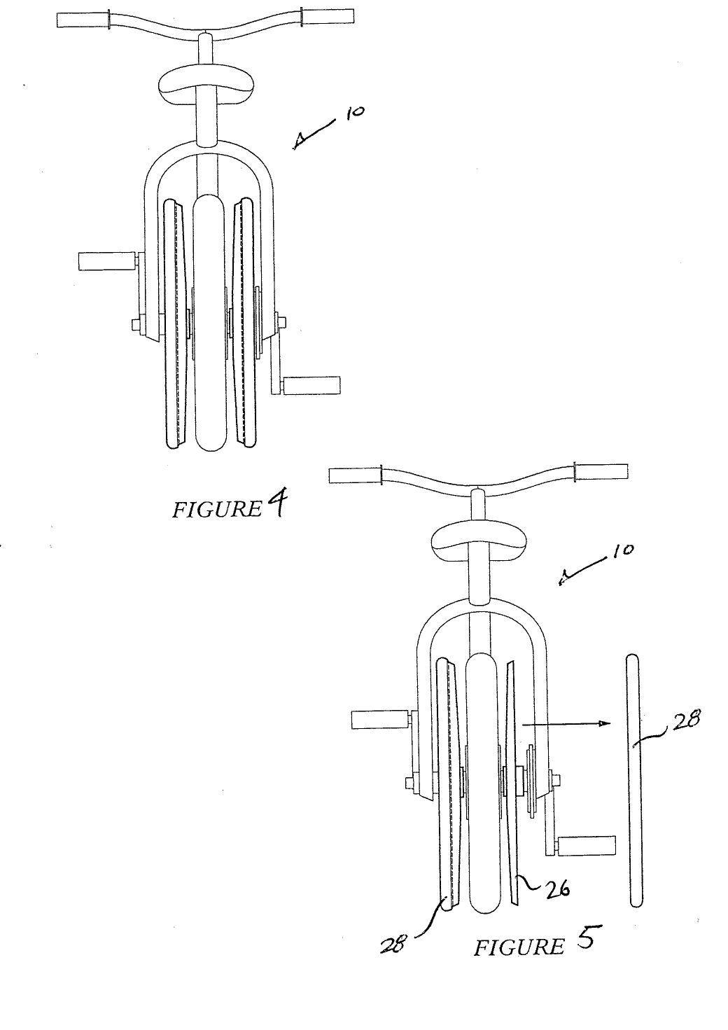

FIG. 1 illustrates a bicycle 10 which includes a rear wheel 12 which has, either integrally formed with the wheel, as illustrated in FIG. 2, or positioned spaced apart from the wheel as illustrated in FIG. 3, a pair of circular supports, respectively designated 14A and 14B.

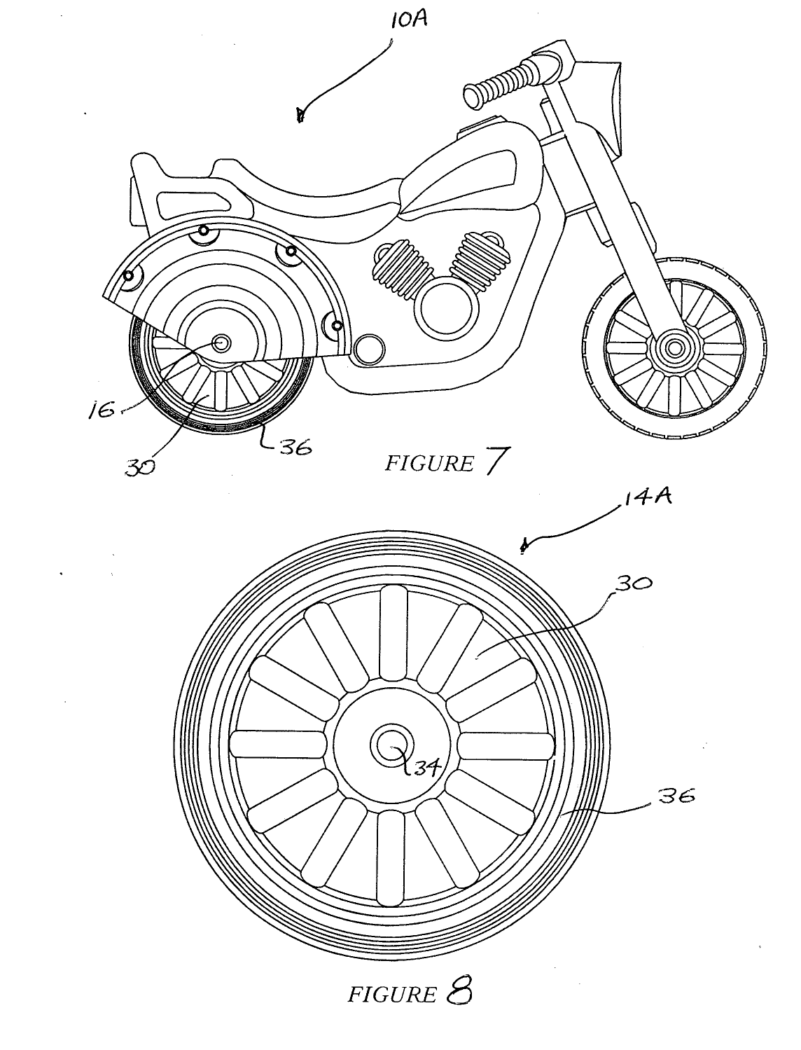

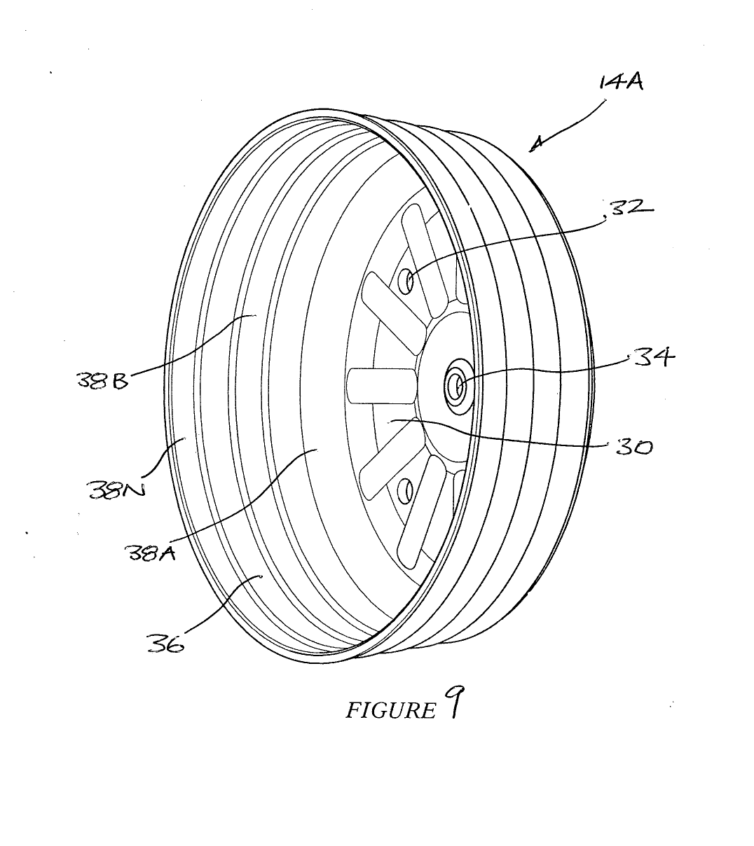

The invention is described with reference to a conventional bicycle 10 as illustrated in FIG. 1 and a cycling trainer 10A, such as those devices made of a moulded wheeled body of a suitable rigid plastics material, as illustrated in FIG. 7.

With reference to FIGS. 2 and 3 respectively each circular support of the pair (14A and 14B) is either attached to a rear axle 16, spaced apart from a respective side of the rear wheel or integrally moulded with the wheel.

Each circular support, whether integrally formed with the rear wheel or attached to and centred on the rear axle, horizontally spaced from the rear wheel, has a dished body 18 made of a suitable rigidly resilient material such as a suitable plastics material with a circular zone 20 of relative weakness which, in this particular embodiment, is a continuous indentation or recess formed in both an inner surface 22 of the body 18 and an outer surface 24 of the body and which divides the body into an inner section 26 and an outer ring section 28.

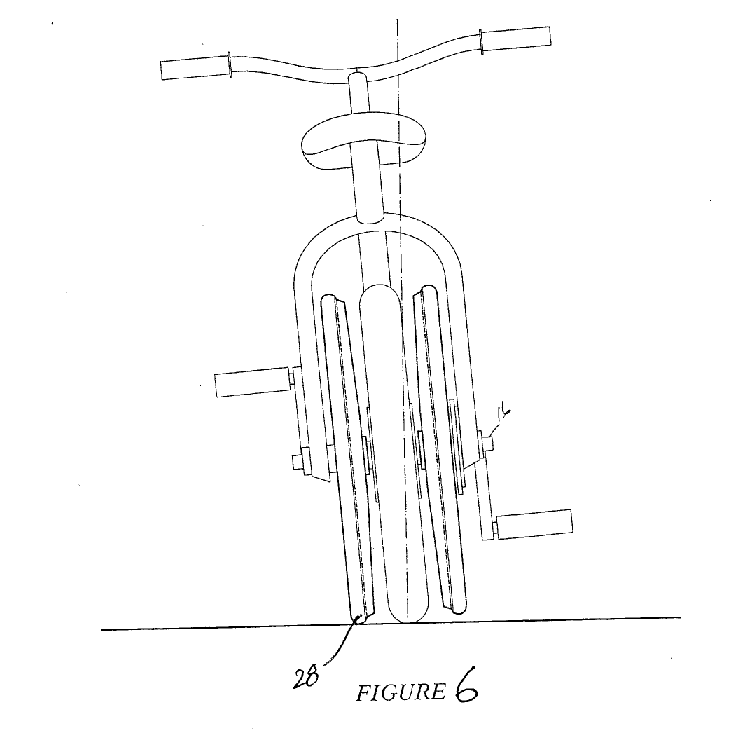

Each support has a diameter of sufficient dimension such that, when the bicycle or trainer is in an upright position in use, a perimeter of the outer ring section 28, is presented to the ground when the bicycle tilts to one side slightly, as illustrated in FIG. 6, to laterally support the rear wheel and provide stability to the bicycle 10 or trainer when a child or a person learning to ride is using the bicycle or trainer.

The diameter of each support can be less than the wheel so that a degree of tilt of the bicycle preferably, is allowed (see FIG. 6) and therefore only when the bicycle and rear wheel tilts to a degree which is sufficient to tip the bicycle does the perimeter of the outer ring 28 come into contact with the road or ground surface.

Preferably however, the diameter of each support and the wheel are the same and, in this embodiment, no tilt is allowed until, after a predetermined period of usage has elapsed, the outer ring section 28 breaks away from the respective support along the zone of weakness leaving the inner section 26 of the body as illustrated in FIG. 5. The predetermined period can be estimated and varied by varying the depth of the recess forming the zone 20. In an alternative embodiment, the outer ring can bend radially inwardly along the zone of weakness, to effectively reduce the diameter of the respective support. The material making up the support can be a resiliently deformable material which will allow the outer ring to return to its original shape, from the bent configuration, when the bicycle returns to the upright or perpendicular position.

The inner section 26, now the remaining portion of the member with the outer ring section removed, has a substantially smaller diameter to that in its original form to an extent that it can no longer provide the lateral support to the wheel as no part of the member can engage the ground without the bicycle or trainer toppling over. In this configuration, the rear wheel and therefore the trainer or bicycle remains laterally unsupported and the learner can ride the bicycle or trainer unsupported, thus after a learning period of support prior to detachment of the outer ring section 28.

The outer ring 28 can be provided with at least one discontinuity (not shown) that is radially arranged, travelling from the zone 20 to the perimeter of the member 14. This discontinuity aids in detaching the outer ring from the member by allowing removal of the outer ring, piece by piece, from the inner section.

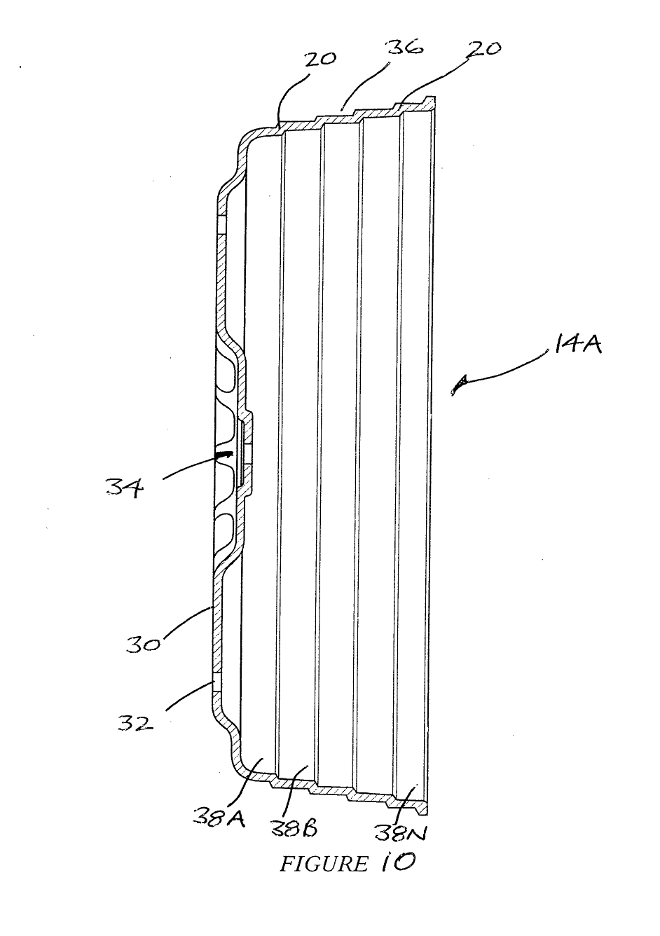

In another embodiment of the invention, now described with reference to the cycling trainer 10A, illustrated in FIG. 7, wherein like features are described with reference to like numeral designators. Each support (14A, 14B) has a barrel-like body and includes an inner wheel component 30 and a lateral support component 36. Therefore, in this embodiment the rear wheel does not exist as a discrete unit, as it does in earlier embodiments, but rather comprises two halves, each half provided by the wheel component 30 of respective supports. As can be seen in FIG. 9 each support has a plurality of recesses 32 though which a bolt or other attachment means can pass to bolt or attach support 14A to 14B on the back axle 16 of the trainer 10A. The axle will pass through central hole 34 when mounting the support 14 to the axle.

The lateral support component 36 of each support 14 includes a plurality of support sections, respectively designated 38A, 38B . . . 38N, the outermost section forming, in this embodiment, the outer ring section 28. Each section meets, in a cross sectional step pattern, at a circular zone 20 of relative weakness.

The relative weakness of these zones may be conferred by being made sectionally thinner than adjacent structure. This structural feature allows the support sections to bend inwardly about at least one zone, but over time, with increased use of the trainer, over a plurality of the zones.

Initially the support will be resilient to inward deformation but, over time, due to material fatigue, the inward deformation will be increasingly permanent thus reducing the diameter of the support and incrementally reducing the lateral support that the support provides as a consequence.

1. A cycling trainer which includes a wheeled body with a rear wheel centred on an axis and a support located on each side of the wheel, to provide lateral support to the rear wheel, wherein each support has at least one circular zone of relative weakness about which the respective support flexes, bends, deflects or breaks.

2. A cycling trainer according to claim 1 wherein the at least one zone includes either a single continuous recess or a plurality of recesses or holes circularly arranged.

3. A cycling trainer according to claim 1 wherein the at least one zone is adapted to be a more resiliently deformable relatively to adjacent sections of the support.

4. A cycling trainer according to claim 3 wherein the at least one zone is sectionally thinner or made of a softer material relatively to adjacent sections of the support.

5. A cycling trainer according to claim 1 wherein each support is centred on the axis, spaced from a respective side of the wheel.

6. A cycling trainer according to claim 1 wherein each support is integrally formed with a respective side of the wheel.

7. A cycling trainer according to claim 1 wherein each support has a dish-shaped or tubular body.

8. A cycling trainer according to claim 7 wherein each dish-shaped support has an outer surface which is concave relatively to the wheel.

9. A cycling trainer according to claim 1 wherein each support includes a plurality of circular zones of relative weakness, concentrically arranged.
